(19) United States
(12) Patent Application Publication
(10) Pub. No.: US 2019/0185306 A1
(43) Pub. Date: Jun. 20, 2019

(54) MULTIFUNCTION RECREATIONAL APPARATUS

(71) Applicant: Ross Rhoades, Charleston, SC (US)

(72) Inventor: Ross Rhoades, Charleston, SC (US)

(21) Appl. No.: 16/218,460

(22) Filed: Dec. 12, 2018

Related U.S. Application Data
(63) Continuation-in-part of application No. 15/133,760, filed on Apr. 20, 2016, now abandoned.
(60) Provisional application No. 62/149,838, filed on Apr. 20, 2015.

(51) Int. Cl. B67B 7/16; B67B 7/00; B65D 47/12

(52) U.S. Cl. CPC B67B 7/16; A24F 3/00; B65D 47/122; B67B 7/24

(57) ABSTRACT

A multifunction recreational apparatus comprising a cap portion, an upper body portion, and a lower body portion. The cap portion is selectively coupled to an upper perimeter of the upper body portion to conceal a bowl portion of a tobacco pipe. Upper body portion comprises a conical grip portion and a tubular member extending from a lower circumference of the conical grip portion. Upper body portion further comprises a channel extending from the bowl portion of upper body portion to a distal end of the tubular member to define an airflow pathway. Lower body portion is conical in shape and increases in diameter from an upper circumference to a lower circumference. A bottom surface of the lower body portion is configured to define a channel, the channel being configured to define a bottle opener.

### CROSS-REFERENCE TO RELATED APPLICATIONS

This application is a continuation-in-part of U.S. patent application Ser. No. 15/133,760 by Ross Rhoades, filed on Apr. 20, 2016 and entitled “SMOKING DEVICES AND METHODS OF MAKING AND USING THE SAME,” claiming priority to U.S. provisional patent application Ser. No. 62/149,838 filed on Apr. 20, 2015 and entitled “SMOKING DEVICES AND METHODS OF MAKING AND USING THE SAME,” the subject matter of said applications is hereby incorporated by reference in its entirety.

### FIELD

The present disclosure relates to the field of recreational multifunction tools; in particular, a combination can opener, bottle opener, and smoking implement.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

An object of the present disclosure is a multifunction recreational apparatus comprising a cap portion comprising an upper surface defining a first circumference and a lower surface defining a second circumference, the lower surface having a threaded receiving portion; a first body portion comprising a grip portion, a threaded upper portion extending from an upper circumference of the grip portion, and a tubular member extending from a lower circumference of the grip portion, the threaded upper portion being removably coupled to the threaded receiving portion of the cap portion, the grip portion being conical in shape and decreasing in diameter from the upper circumference to the lower circumference; and, a second body portion removably coupled to the first body portion, the second body portion being conical in shape and increasing in diameter from an upper circumference to a lower circumference, the second body portion having an air inlet disposed on a lower surface of the second body portion, and having an elongated aperture extending from the upper circumference to a terminal portion adjacent to the air inlet, the elongated aperture being configured to receive the tubular member of the first body portion.

Another object of the present disclosure is a multifunction recreational apparatus comprising a cap portion comprising an upper surface defining a first circumference and a lower surface defining a second circumference; a first body portion comprising a grip portion, a concave bowl portion, and a tubular member extending from a distal end of the grip portion, the grip portion being removably coupled to the cap portion, the grip portion being conical in shape and decreasing in diameter from the upper circumference to the lower circumference; and, a second body portion removably coupled to the first body portion, the second body portion being conical in shape and increasing in diameter from an upper circumference to a lower circumference, the second body portion having an air inlet disposed on a lower surface of the second body portion, and having an elongated aperture extending from the upper circumference to the air inlet, the elongated aperture being configured to receive the tubular member of the first body portion, the tubular member and the air inlet defining an airflow pathway.

Yet another object of the present disclosure is a multifunction recreational apparatus comprising a cap portion comprising an upper surface defining a first circumference and a lower surface defining a second circumference; a first body portion comprising a grip portion, a concave bowl portion, a tubular member extending from a distal end of the grip portion, and an elongated aperture extending from the concave bowl portion to a distal end of the tubular member, the grip portion being removably coupled to the cap portion, the grip portion being conical in shape and decreasing in diameter from the upper circumference to the lower circumference; and, a second body portion removably coupled to the first body portion, the second body portion being conical in shape and increasing in diameter from an upper circumference to a lower circumference, the second body portion having an air inlet disposed on a lower surface of the second body portion, and having an elongated aperture extending from the upper circumference to the air inlet, the elongated aperture being configured to receive the tubular member of the first body portion, the elongated aperture of the first body portion and the air inlet defining an airflow pathway.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The above and other objects, features and advantages of the present disclosure will be more apparent from the following detailed description taken in conjunction with the accompanying drawings, in which:

FIG. 1 is a plan view of a multifunction recreational apparatus, according to an embodiment of the present disclosure;

FIG. 2A is a functional view of a multifunction recreational apparatus, according to an embodiment of the present disclosure;

FIG. 2B is a functional view of a multifunction recreational apparatus, according to an embodiment of the present disclosure;

FIG. 3 is a plan view of a multifunction recreational apparatus, according to an embodiment of the present disclosure;

FIG. 4 is a bottom up plan view of a multifunction recreational apparatus, according to an embodiment of the present disclosure;

FIG. 5A is a functional view of a multifunction recreational apparatus, according to an embodiment of the present disclosure;

FIG. 5B is a functional view of a multifunction recreational apparatus, according to an embodiment of the present disclosure;

FIG. 6 is a functional view of a multifunction recreational apparatus, according to an embodiment of the present disclosure;

FIG. 7A is a functional view of a multifunction recreational apparatus, according to an embodiment of the present disclosure;

FIG. 7B is a functional view of a multifunction recreational apparatus, according to an embodiment of the present disclosure;

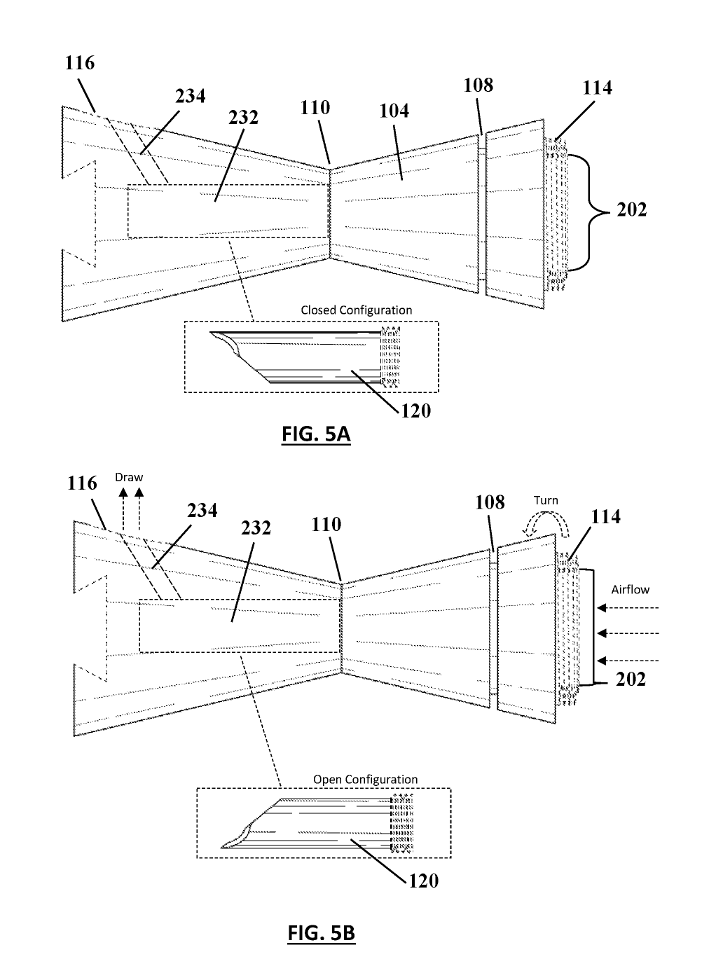

FIG. 5A is a functional view of a multifunction recreational apparatus, according to an embodiment of the present disclosure;

FIG. 8 is a perspective view of a multifunction recreational apparatus, according to an embodiment of the present disclosure;

FIG. 9 is a top down plan view of a tobacco pipe assembly of multifunction recreational apparatus, according to an embodiment of the present disclosure;

FIG. 10 is a bottom up plan view of a tobacco pipe assembly of multifunction recreational apparatus, according to an embodiment of the present disclosure;

FIG. 11 is a functional diagram of a method of use for a multifunction recreational apparatus, according to an embodiment of the present disclosure;

FIG. 12 is a functional diagram of a method of use for a multifunction recreational apparatus, according to an embodiment of the present disclosure;

FIG. 13 is an exploded view of a multifunction recreational apparatus, according to an embodiment of the present disclosure;

FIG. 14A is a functional view of a multifunction recreational apparatus, according to an embodiment of the present disclosure; and,

FIG. 14B is a functional view of a multifunction recreational apparatus, according to an embodiment of the present disclosure.

### DETAILED DESCRIPTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

The terminology used herein is for describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,”, and variants thereof, when used herein, specify the presence of stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to another element, it can be directly coupled, connected, or responsive to the other element, or intervening elements may also be present. In contrast, when an element is referred to as being “directly coupled,” “directly connected,” or “directly responsive” to another element, there are no intervening elements present. As used herein, the term “and/or” includes any and all combinations of one or more of the associated listed items.

Spatially relative terms, such as “above,” “below,” “upper,” “lower,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly. Well-known functions or constructions may not be described in detail for brevity and/or clarity.

It will be understood that, although the terms “first,” “second,” etc. may be used herein to describe various elements, these elements should not be limited by these terms. These terms are only used to distinguish one element from another. Thus, a first element could be termed a second element without departing from the teachings of the present embodiments. Unless otherwise defined, all terms (including technical and scientific terms) used herein have the same meaning as commonly understood by one of ordinary skill in the art to which these embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Embodiments of the present disclosure provide for a multifunction recreational apparatus comprising a cap portion, an upper body portion, and a lower body portion. The cap portion is selectively coupled to an upper perimeter of the upper body portion to conceal a bowl portion of a tobacco pipe. Upper body portion comprises a conical grip portion and a tubular member extending from a lower circumference of the conical grip portion. The conical grip portion tapers in diameter from an upper circumference to a lower circumference. Upper body portion further comprises a channel extending from the bowl portion of upper body portion to a distal end of the tubular member to define an airflow pathway. Lower body portion is conical in shape and increases in diameter from an upper circumference to a lower circumference. Lower body portion comprises an inlet disposed on a lower surface of the lower body portion, and a substantially cylindrical aperture extending internally from the upper perimeter to the location of the inlet. A bottom surface of the lower body portion is configured to define a channel, the channel being configured to define a bottle opener.

Specific embodiments of the present disclosure provide for a multifunction recreational apparatus comprising: (I) a tubular member comprising a first end, a second end opposite said first end, a tubular member cavity extending through said tubular member from said first end to said second end, said tubular member cavity having a first opening at said first end, said first opening having a first cross-sectional area that is greater than a second cross-sectional area as positioned along said tubular member cavity between said first opening and said second end, a bowl portion at said first end, said bowl portion comprising said first opening and having a conical shape along a length thereof, wherein an outer diameter of said tubular member decreases along said bowl portion to a bowl end, a stem portion extending from said bowl end of said bowl portion to said second end, said stem having a substantially constant outer diameter from said bowl end to said second cross-sectional area, wherein said second cross-sectional area is positioned along said tubular member cavity and perpendicular to a dissecting axis of said tubular member, and one or more second end edges along said second end, said one or more second end edges having a combined edge length that is greater than an outer circumference of said tubular member at said one or more second end edges that is closest to said first end (II) a housing member comprising a housing first end, a housing second end opposite said housing first end, a housing cavity extending into said housing first end towards said housing second end, said housing cavity having a first housing opening at said housing first end, said housing first opening being sized so as to extend over at least a portion of said tubular member that extends from said second end towards said first end, said housing member having a sheath configuration that extend over said tubular member from said second end to at least said bowl end of said bowl portion of said tubular member, and a bottle opener along a bottom surface of said housing member at said housing second end; and (III) a cap member comprising a cap member first end, a cap member second end opposite said cap member first end, said cap member second end being sized to extend over said first opening of said tubular member cavity, and cap member connectors that can be used to connect said cap member to corresponding connectors on at least one of said tubular member and said housing member.

Further specific embodiments of the present disclosure provide for a multifunction recreational apparatus comprising: (I) a tubular member comprising a first end, a second end opposite said first end, a tubular member cavity extending through said tubular member from a first opening at said first end to one or more second openings between said first opening and said second end, a bowl portion at said first end, said bowl portion comprising said first opening and having a conical shape along a length thereof, wherein an outer diameter of said tubular member decreases along said bowl portion to a bowl end, a stem portion extending from said bowl end of said bowl portion to said second end, said stem having a substantially constant outer diameter from said bowl end to said second cross-sectional area, wherein said second cross-sectional area is positioned along said tubular member cavity and perpendicular to a dissecting axis of said tubular member, tubular member threads positioned along said tubular member, and one or more second end edges along said second end, said one or more second end edges having a combined edge length that is greater than an outer circumference of said tubular member at said one or more second end edges that is closest to said first end; (II) a housing member comprising a housing first end, a housing second end opposite said housing first end, and a housing cavity extending into said housing first end towards said housing second end, said housing cavity having a first housing opening at said housing first end, said housing first opening being sized so as to extend over at least a portion of said tubular member that extends from said second end towards said first end, housing member threads positioned along said housing member; and (III) a cap member comprising a cap member first end, a cap member second end opposite said cap member first end, said cap member second end being sized to extend over said first opening of said cavity, and cap member threads positioned along said cap member.

Further specific embodiments of the present disclosure provide for a multifunction recreational apparatus comprising: (I) a tubular member comprising a first end, a second end opposite said first end, a tubular member cavity extending through said tubular member from said first end to said second end, said tubular member cavity having a first opening at said first end, said first opening having a first cross-sectional area that is greater than a second cross-sectional area positioned along said tubular member cavity between said first opening and said second end, a bowl portion at said first end, said bowl portion comprising said first opening and having a conical shape along a length thereof, wherein an outer diameter of said tubular member decreases along said bowl portion to a bowl end, a stem portion extending from said bowl end of said bowl portion to said second end, said stem having a substantially constant outer diameter from said bowl end to said second cross-sectional area, wherein said second cross-sectional area is positioned along said tubular member cavity and perpendicular to a dissecting axis of said tubular member, tubular member threads positioned along said tubular member, and one or more second end edges along said second end, said one or more second end edges having a combined edge length that is greater than an outer circumference of said tubular member at said one or more second end edges that is closest to said first end; (II) a housing member comprising a housing first end, a housing second end opposite said housing first end, a housing cavity extending into said housing first end towards said housing second end, said housing cavity having a first housing opening at said housing first end, said housing first opening being sized so as to extend over at least a portion of said tubular member that extends from said second end towards said first end, said housing member having a sheath configuration that extend over said tubular member from said second end to at least said bowl end of said bowl portion of said tubular member, housing member threads positioned along said housing member, one or more end surface portions that enable said housing member to stand on its housing second end, and a bottle opener along a bottom surface of said housing member at said housing second end; and (III) a cap member comprising a cap member first end, a cap member second end opposite said cap member first end, said cap member second end being sized to extend over said first opening of said tubular member cavity, a cap member first end upper surface at said cap member first end and two or more cap member wall portions extending upward from said cap member first end upper surface, one or more cap member holes extending thru one or more of said two or more cap member wall portions, each cap member hole being sized to allow a key chain component to extend therethrough, and cap member threads positioned along said cap member, said cap member threads enabling connection of said cap member to at least one of said tubular member and said housing member.

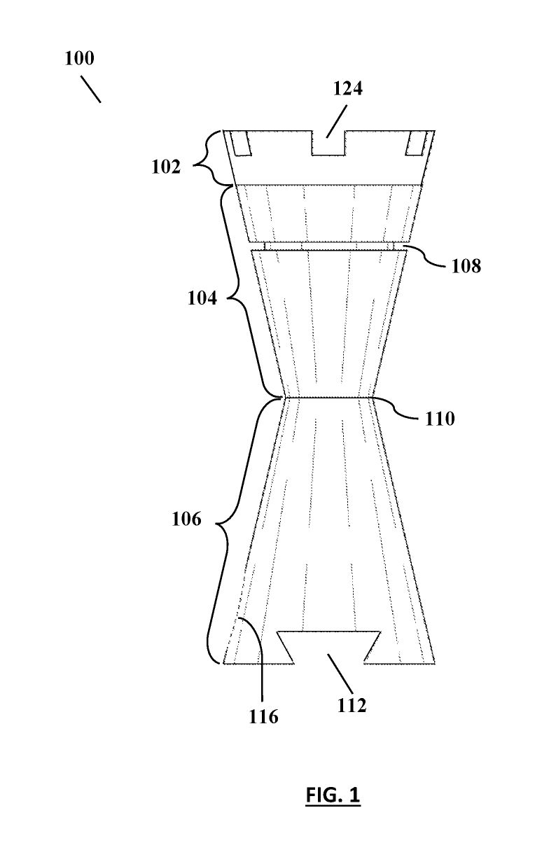

Referring now to FIG. 1, a plan view of a multifunction recreational apparatus 100 is shown. According to an embodiment of the present disclosure, multifunction recreational apparatus 100 is generally comprised of cap portion 102, upper body portion 104, and lower body portion 106. Cap portion 102 may be cylindrical in shape and may decrease in circumference from an upper surface to a lower surface. Cap portion 102 is selectively coupled to upper body portion 104, and upper body portion 104 is selectively coupled to lower body portion 106. Upper body portion 104 and lower body portion 106 interface at a midpoint 110 when selectively coupled together. Upper body portion 104 may define a grip portion, and lower body portion 106 may define a base portion. One or more slots or channels 124 may be disposed on an arc of upper surface of cap portion 102. One or more slots or channels 124 may be configured to receive a key ring and may be configured for other utilities such as prying open bottles and/or cans. A bottle interface channel 108 may be disposed on a surface of body portion 104. Lower body portion 106 may comprise a slotted portion 112 disposed on a bottom surface of lower body portion 106. Slotted portion 112 may be trapezoidal in shape and may be configured to receive a bottle cap from a standard size beer bottle. Slotted portion 112 may be constructed of metal or plastic of sufficient tensile strength to pry off a bottle cap from a standard size beer bottle. Lower body portion 106 may further comprise a mouth piece 116 defining an air inlet disposed on a surface of lower body portion 106. Cap portion 102, upper body portion 104, and lower body portion 106 may be hourglass in shape when coupled together in a closed configuration. Upper body portion 104 and lower body portion 106 may be constructed of plastic, metal, wood, and the like.

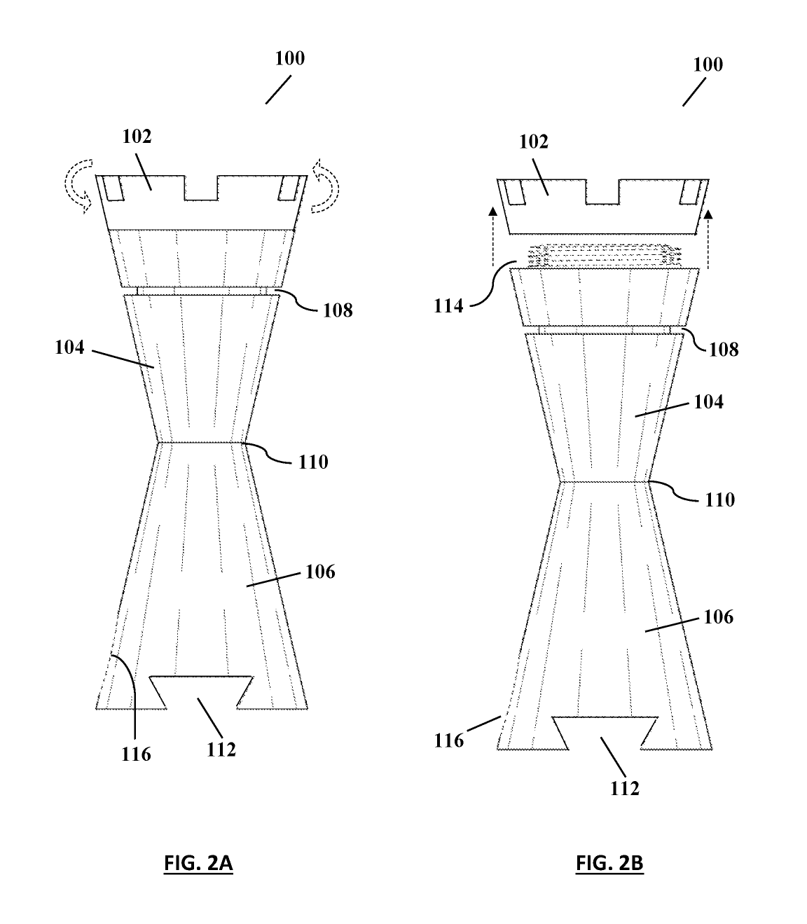

Referring now to FIGS. 2A and 2B, functional views of multifunction recreational apparatus 100 is shown. According to an embodiment of the present disclosure, a user may configure multifunction recreational apparatus 100 from a closed configuration (as shown in FIG. 1) to an engaged configuration. A user may selectively remove cap portion 102 from upper body portion 104 by rotating cap portion 102 to disengage cap portion 102 from threaded portion 114. While multifunction recreational apparatus 100 interfaces threaded portion 114 with a threaded portion of cap portion 102 to selectively couple cap portion 102 and upper body portion 104, any number of mechanical mating means are readily anticipated, such as keyed grooves, matable interfaces, and the like. Upon disengaging cap portion 102 from upper body portion 104, the user removes cap portion 102 to prepare multifunction recreational apparatus 100 for use.

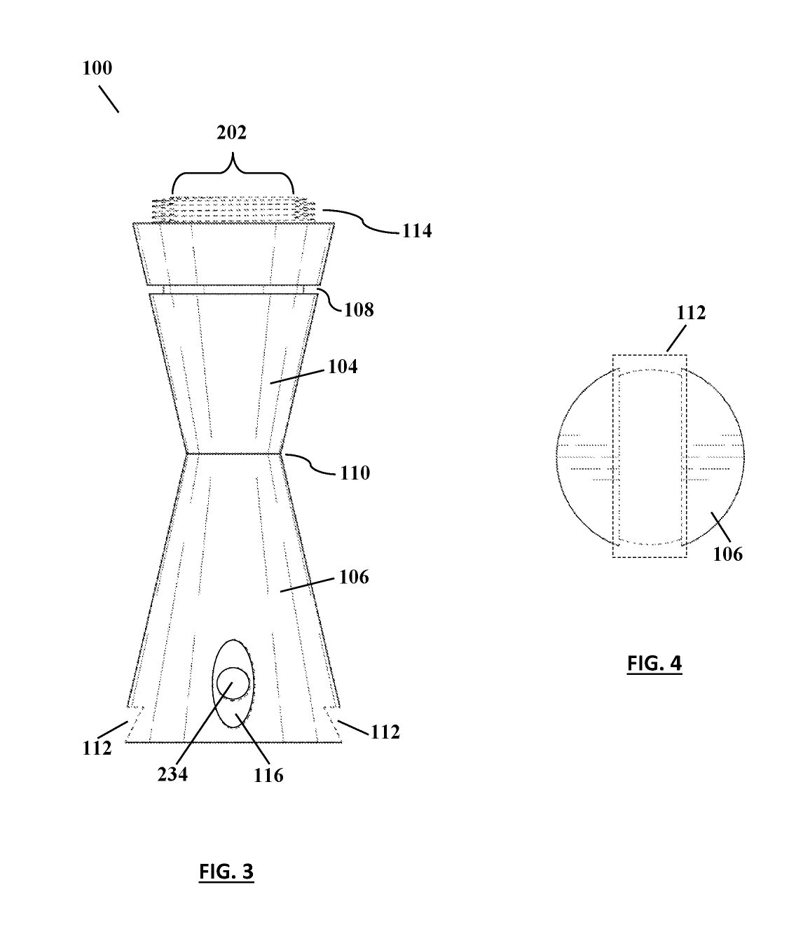

Referring now to FIG. 3, a plan view of multifunction recreational apparatus 100 is shown. According to an embodiment of the present disclosure, threaded portion 114 defines an upper circumference of bowl portion 202. Bowl portion 202 comprises a concave surface (as shown in FIG. 9) and extends internally within upper body portion 104. An airflow inlet 234 extends from mouth piece 116.

Referring now to FIG. 4, a bottom up plan view of multifunction recreational apparatus 100 is shown. According to an embodiment of the present disclosure, FIG. 4 provides a more detailed view of the bottom surface of lower body portion 106. As discussed above, lower body portion 106 is cylindrical in shape and defines a lower circumference, as shown in FIG. 4. A slotted aperture 112 is disposed on the lower circumference of lower body portion 106 and may extend the entire diameter of lower body portion 106 in length and may have a width spanning a portion of the lower circumference of lower body portion 106 in the range of about 30 degrees to about 50 degrees on opposite sides of the circumference.

Referring now to FIGS. 5A and 5B, functional views of multifunction recreational apparatus 100 is shown. According to an embodiment of the present disclosure, multifunction recreational apparatus 100 may be utilized as a smoking pipe. Upper body portion 104 may further comprise tubular member 120. Tubular member 120 may be housed in an elongated aperture 232 of lower body portion 106. Tubular member 120 may be constructed as a truncated cylinder at a distal end, defining a long side and a short side and terminating at a point along the long side. Airflow inlet 234 may extend from mouthpiece 116 to elongated aperture 232 defining an airflow path. When in a closed configuration (as shown in FIG. 5A), the long side of the distal end of tubular member 120 functions to block the airflow pathway of airflow inlet 234. To open the airflow pathway, the user turns upper body portion 104 to align the short side of the distal end of tubular member 120 with airflow inlet 234. The user may then draw with the user's mouth on mouthpiece 116 to draw smoke from lit tobacco contained in bowl portion 202.

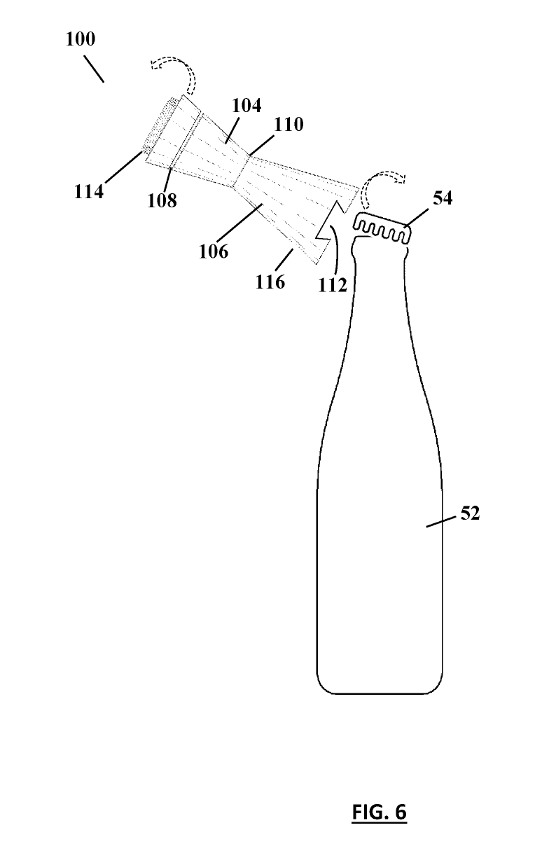

Referring now to FIG. 6, a functional view of multifunction recreational apparatus 100 is shown. According to an embodiment of the present disclosure, multifunction recreational apparatus 100 may be configured for use as a bottle opener. A user may interface slotted portion 112 with a bottle cap 54 of a standard size glass beer bottle 52. The user may then apply downward pressure on upper body portion 104 in order to pry bottle cap 54 from beer bottle 52.

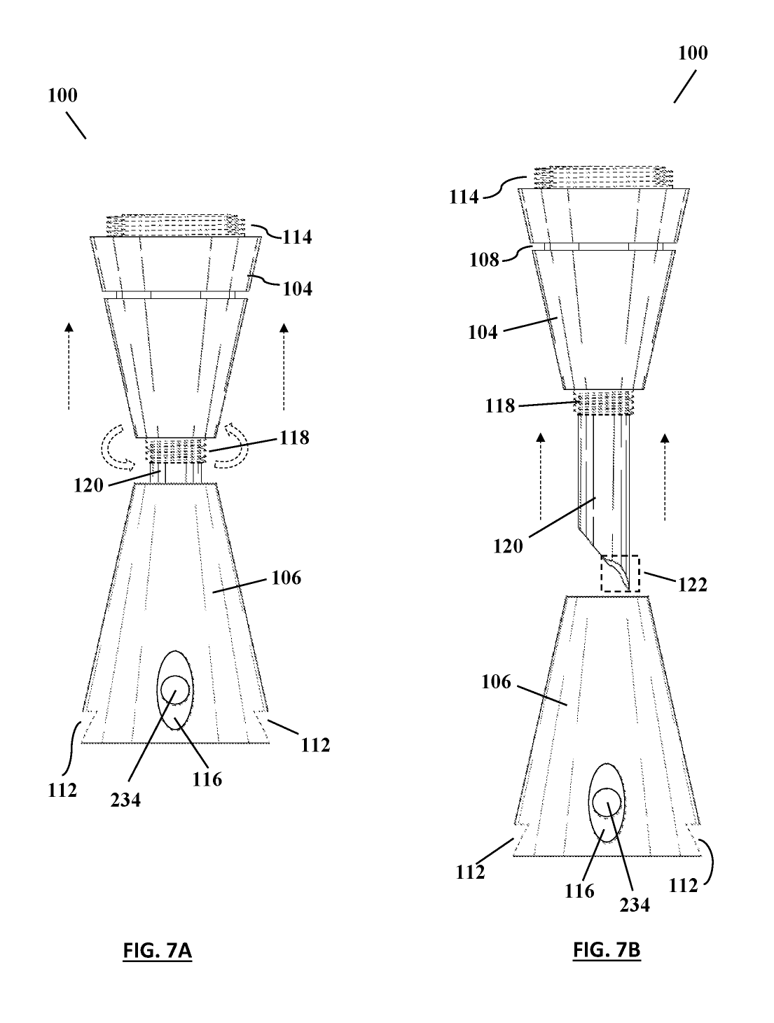

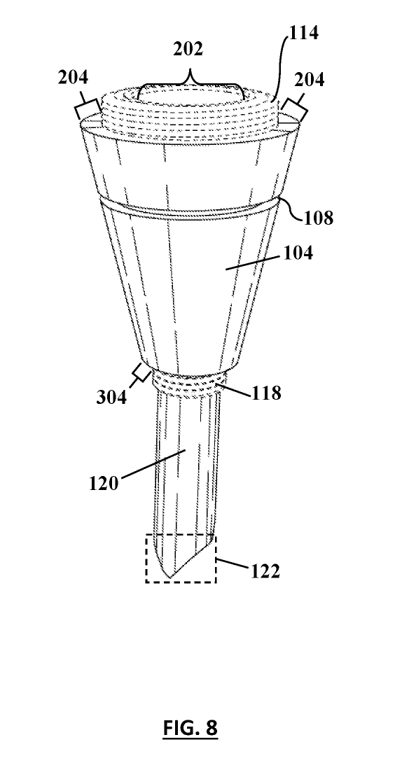

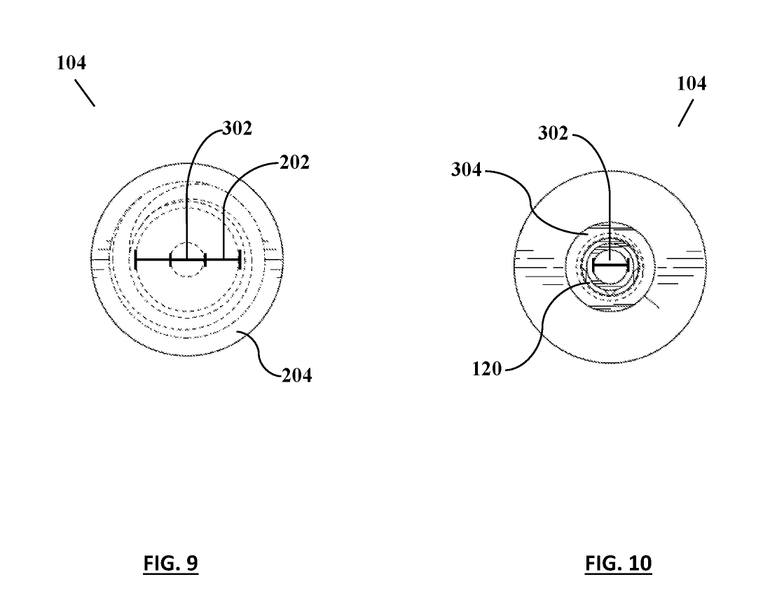

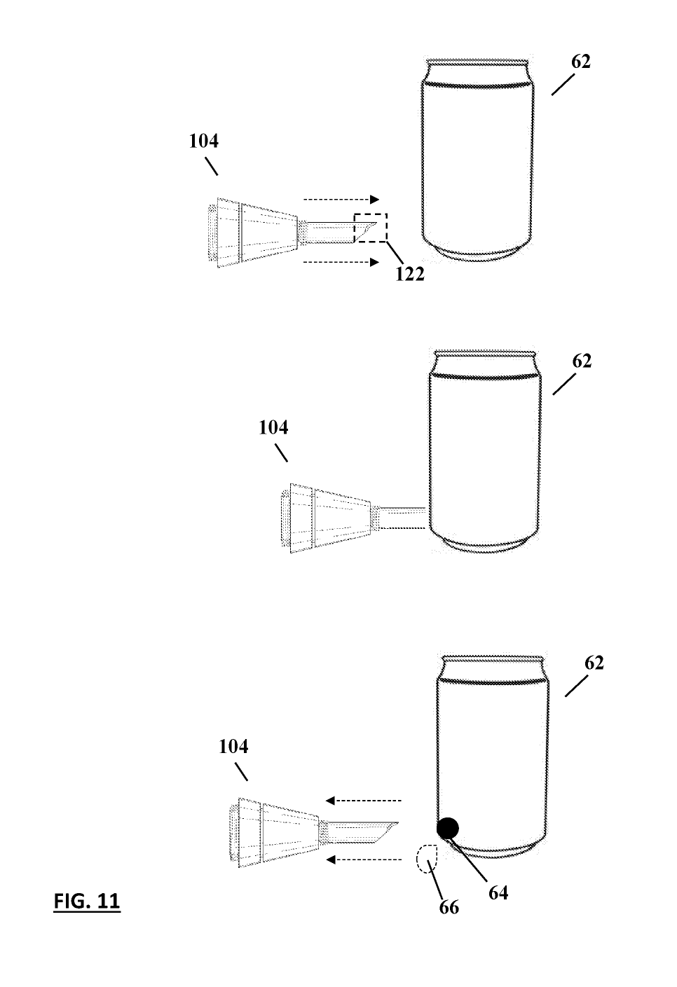

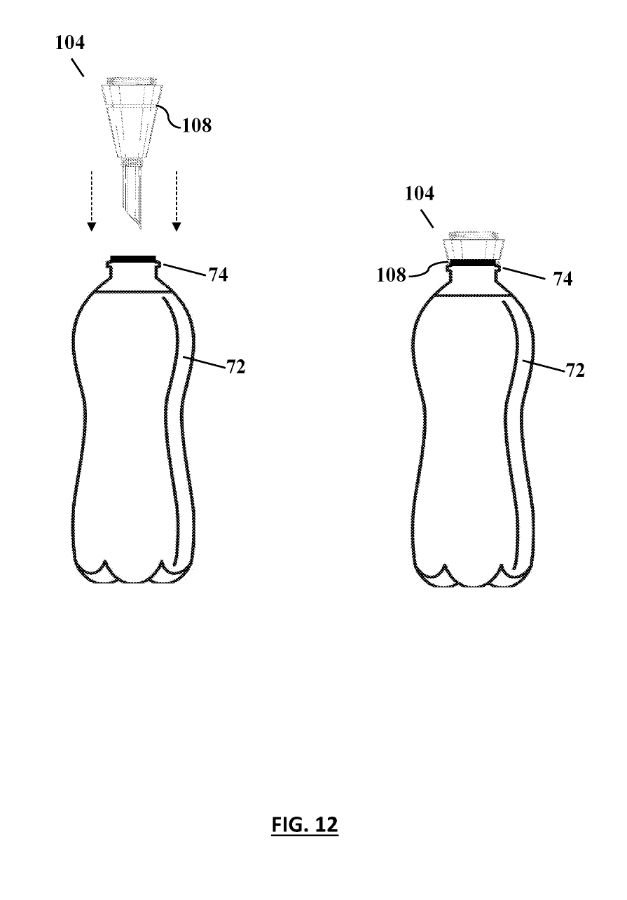

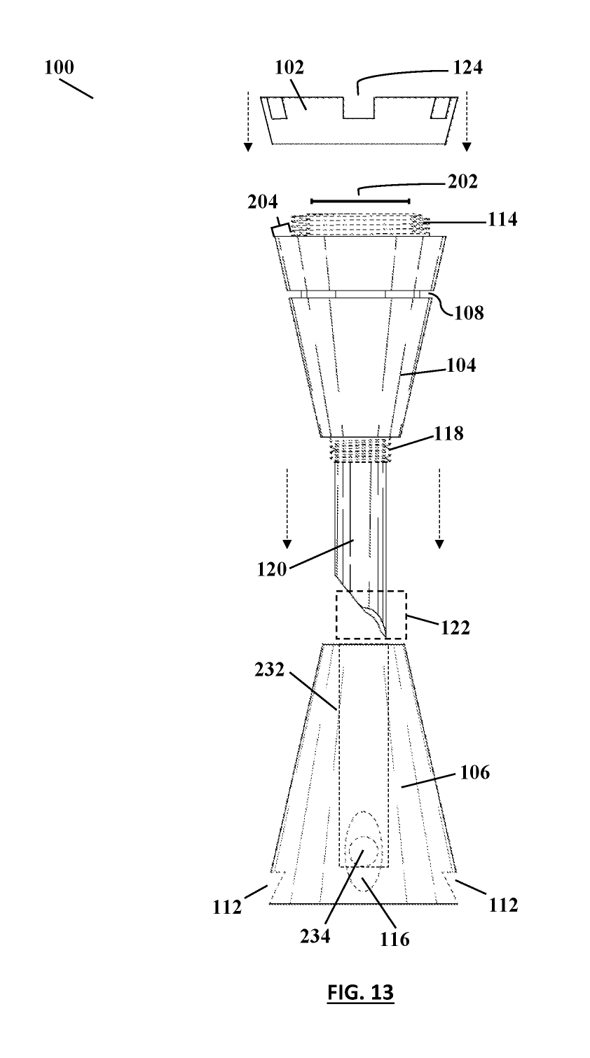

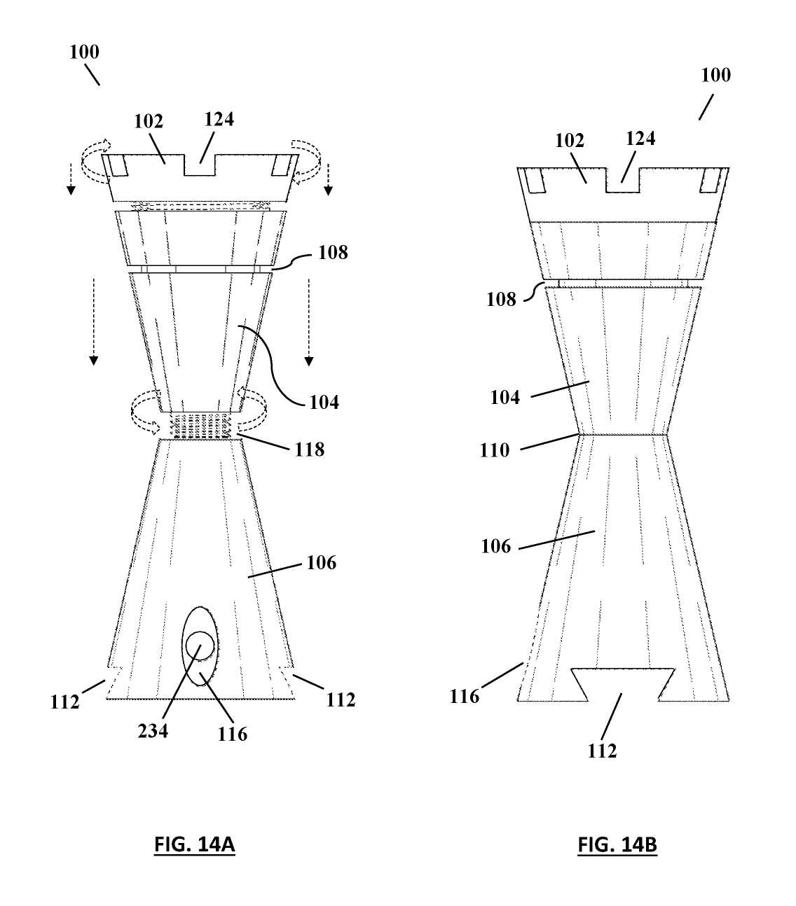

Referring now to FIGS. 7A and 7B, functional views of multifunction recreational apparatus 100 is shown. According to an embodiment of the present disclosure, a user may disengage upper body portion 104 from lower body portion 106 by twisting upper body portion 104 to disengaged threaded portion 118 from lower body portion 106. While upper body portion 104 interfaces with lower body portion 106 via threaded portion 118 according to an embodiment, it is anticipated that any number of mechanical mating means may be readily substituted for threaded portion 118, such as keyed grooves, matable interfaces, and the like. As discussed above, tubular member 120 may be configured as a truncated cylinder at a distal end, defining a long side and a short side and terminating at a point along the long side to define a piercing portion 122.

Referring now to FIG. 8, a perspective view of multifunction recreational apparatus 100 is shown. According to an embodiment of the present disclosure, upper body portion 104 is illustrated in a disconnected configuration. In more detail, upper body portion 104 may further comprise upper surface 204 defining an upper circumference of upper body portion 104; and, lower surface 304 defining a lower circumference of upper body portion 104. Tubular member 120 may be hollow and define an elongated aperture 302 (shown in FIGS. 9 and 10) extending from bowl portion 202 to piercing portion 122. Referring now to FIGS. 9 and 10, a top down and bottom up plan view of upper body portion 104 is shown. According to an embodiment of the present disclosure, bowl portion 202 is disposed on upper surface 204 of upper body portion 104. Bowl portion 202 is concave in shape and defines an upper end of elongated aperture 302. Elongated aperture 302 is further defined by an internal surface of tubular member 120 and defines an airflow pathway from a proximal end to a distal end of upper body portion 104.

Referring now to FIG. 11, a functional diagram of a method of use for multifunction recreational apparatus 100 is shown. According to an embodiment of the present disclosure, a user may utilize upper body portion 104 in a disconnected configuration to piece a surface of an aluminum can. A user may apply lateral force to upper body portion 104 in order to drive piercing portion 122 into a surface of an aluminum can 62. Once the user has pierced the surface of aluminum can 62 with piercing portion 122, the user may remove upper body portion 104 from can 62 to create hole 64 in order to rapidly evacuate liquid 66 from can 62.

Referring now to FIG. 12, a functional diagram of a method of use for multifunction recreational apparatus 100 is shown. According to an embodiment of the present disclosure, a user may interface upper body portion 104 with a plastic beverage bottle 72 by engaging bottle interface channel 108 with a pour spout 74 of plastic bottle 72. Upper body portion 104 and bottle interface channel 108 should be configured to create an air tight seal with pour spout 74 of plastic bottle 72.

Referring now to FIG. 13, an exploded view of multifunction recreational apparatus 100 is shown. According to an embodiment of the present disclosure, when a user wishes to store multifunction recreational apparatus 100 during periods of non-use or transport, the user selectively couples cap portion 102 to upper body portion 104, and selectively couples upper body portion 104 to lower body portion 106. The user inserts tubular member 120 into elongated aperture 232 of lower body portion 106. The user interfaces cap portion 102 with threaded portion 114. The user interfaces threaded portion 114 with lower body portion 106. Referring now to FIGS. 14A and 14B, the user selectively couples cap portion 102 with upper body portion 104 by turning cap portion 102 with threaded portion 114 until threaded portion 114 is fully engaged with cap portion 102. The user selectively couples upper body portion 104 with lower body portion 106 by turning upper body portion 104 until threaded portion 118 is fully engaged with lower body portion 106. Upon selectively coupling cap portion 102, upper body portion 104, and lower body portion 106, multifunction recreational apparatus 100 is constructed to be substantially air tight and water tight, such that no water can enter the interior portions of multifunction recreational apparatus 100 when submerged in water in a closed configuration; and, no odors from can be emanated from the interior portions of multifunction recreational apparatus 100 when in a closed configuration.

Multifunction recreational apparatus 100 may be constructed of plastic, metal, wood, or combinations thereof, and should be constructed to withstand drops from at least 30 feet and full submersion under water. Multifunction recreational apparatus 100 may be approximately 2 inches to 4 inches in height, and more preferably about 3 inches in height. Multifunction recreational apparatus 100 may have a diameter in the range of about half an inch to about 2 inches at an upper and lower circumference of multifunction recreational apparatus 100; and, more preferably, may have a diameter of about one inch at an upper and lower circumference. Multifunction recreational apparatus 100 may be hourglass in shape and may have a diameter in the range of about 0.25 inch to about 1 inch at midpoint 110. Multifunction recreational apparatus 100 may be selectively configured to one or more configurations to enable a user to utilize multifunction recreational apparatus 100 as a smoking implement, a bottle opener, and a can opener. Multifunction recreational apparatus 100 should be configured to store tobacco in an interior portion of multifunction recreational apparatus 100 and should be airtight and watertight with respect to storage of said tobacco. Multifunction recreational apparatus 100 may include other tools such as a wrench, screw driver, pocket knife, flashlight, USB drive, car key, plyers, and the like.

The present disclosure includes that contained in the appended claims as well as that of the foregoing description. Although this invention has been described in its exemplary forms with a certain degree of particularity, it is understood that the present disclosure of has been made only by way of example and numerous changes in the details of construction and combination and arrangement of parts may be employed without departing from the spirit and scope of the invention. Therefore, it will be apparent to those skilled in the art that various modifications and variations can be made to the disclosed embodiments without departing from the scope or spirit of the invention. In view of the foregoing, it is intended that the invention covers modifications and variations of this disclosure within the scope of the following claims and their equivalents.

What is claimed is:

1. A multifunction recreational apparatus comprising:
a cap portion comprising an upper surface defining a first circumference and a lower surface defining a second circumference, the lower surface having a threaded receiving portion;
a first body portion comprising a grip portion, a threaded upper portion extending from an upper circumference of the grip portion, and a tubular member extending from a lower circumference of the grip portion, the threaded upper portion being removably coupled to the threaded receiving portion of the cap portion, the grip portion being conical in shape and decreasing in diameter from the upper circumference to the lower circumference; and,
a second body portion removably coupled to the first body portion, the second body portion being conical in shape and increasing in diameter from an upper circumference to a lower circumference, the second body portion having an air inlet disposed on a lower surface of the second body portion, and having an elongated aperture extending from the upper circumference to a terminal end adjacent to the air inlet, the elongated aperture being configured to receive the tubular member of the first body portion.

2. The apparatus of claim 1 wherein the upper surface of the cap portion further comprises at least one slotted aperture disposed on an arc of the first circumference.

3. The apparatus of claim 1 further comprising a slotted aperture disposed on the lower circumference of the second portion, the slotted aperture being configured as a bottle opener.

4. The apparatus of claim 1 wherein the tubular member is configured as a truncated cylinder at a distal end to define a piercing portion.

5. The apparatus of claim 1 further comprising a threaded portion disposed on an upper surface of the tubular member.

6. The apparatus of claim 1 wherein the first body portion further comprises a bowl portion, the threaded upper portion defining an upper circumference of the bowl portion.

7. A multifunction recreational apparatus comprising:
a cap portion comprising an upper surface defining a first circumference and a lower surface defining a second circumference;
a first body portion comprising a grip portion, a concave bowl portion, and a tubular member extending from a distal end of the grip portion, the grip portion being removably coupled to the cap portion, the grip portion being conical in shape and decreasing in diameter from the upper circumference to the lower circumference; and,
a second body portion removably coupled to the first body portion, the second body portion being conical in shape and increasing in diameter from an upper circumference to a lower circumference, the second body portion having an air inlet disposed on a lower surface of the second body portion, and having an elongated aperture extending from the upper circumference to the air inlet, the elongated aperture being configured to receive the tubular member of the first body portion, the tubular member and the air inlet defining an airflow pathway.

8. The apparatus of claim 7 wherein the tubular member is configured as a truncated cylinder at a distal end to define a piercing portion.

9. The apparatus of claim 8 wherein the piercing portion is selectively configured to open and close the airflow pathway.

10. The apparatus of claim 7 further comprising an aperture disposed around a circumference of the grip portion, the aperture being configured to interface with a pour spout of a plastic beverage bottle.

11. The apparatus of claim 7 further comprising a slotted aperture disposed on the lower circumference of the second portion, the slotted aperture being configured as a bottle opener.

12. A multifunction recreational apparatus comprising:
a cap portion comprising an upper surface defining a first circumference and a lower surface defining a second circumference;
a first body portion comprising a grip portion, a concave bowl portion, a tubular member extending from a distal end of the grip portion, and an elongated aperture extending from the concave bowl portion to a distal end of the tubular member, the grip portion being removably coupled to the cap portion, the grip portion being conical in shape and decreasing in diameter from the upper circumference to the lower circumference; and,
a second body portion removably coupled to the first body portion, the second body portion being conical in shape and increasing in diameter from an upper circumference to a lower circumference, the second body portion having an air inlet disposed on a lower surface of the second body portion, and having an elongated aperture extending from the upper circumference to the air inlet, the elongated aperture being configured to receive the tubular member of the first body portion, the elongated aperture of the first body portion and the air inlet defining an airflow pathway.

13. The apparatus of claim 12 further comprising a slotted aperture disposed on the lower circumference of the second portion, the slotted aperture being configured as a bottle opener.

14. The apparatus of claim 12 wherein the tubular member is configured as a truncated cylinder at a distal end to define a piercing portion.

15. The apparatus of claim 14 wherein the piercing portion is selectively configured to open and close the airflow pathway.
